(19) United States
(12) Patent Application Publication
(10) Pub. No.: US 2019/0388939 A1
(43) Pub. Date: Dec. 26, 2019

(54) VISION ENABLED APPARATUS FOR SORTING PARTS AND SYSTEMS AND METHODS THEREFOR

(71) Applicant: D & D Automation Inc., Stratford (CA)

(72) Inventors: Glen Albert Bell, Waterloo (CA); Joshua Bailey, Listowel (CA); Angelos KOTZAMBASIS, Waterloo (CA); John Crocker, Waterloo (CA); Matthew BORDMAN, St. Marys (CA); Mark De Groot, Poole (CA)

(73) Assignee: D & D Automation Inc., Stratford (CA)

(21) Appl. No.: 16/015,013

(22) Filed: Jun. 21, 2018

(51) Int. Cl. B07C 1/04; B07C 5/36; B07C 5/342

(52) U.S. Cl. CPC B07C 1/04; B07C 5/3422; B07C 5/367

(57) ABSTRACT

A parts feeder which incorporates a position-controlled conveyor, a unique flex crowder system and destacker for promoting the singulation of parts on the conveyor, and a vision enabled reject mechanism to select and reject non-compliant parts. In this regard, parts to be sorted are lifted onto a conveyor and run past a series of adjustable crowder sections, including a flex crowder section, past a destacker element and into a singulation zone whereupon multiple camera images of both edges and features in conjunction with conveyor speed, conveyor position and laser triggering synchronize the parts to be rejected. The parts feeder incorporates adjustable settings thereby obviating the need to switch out components for the purpose of accommodating parts of various shapes and sizes.

### TECHNICAL FIELD

This disclosure relates to parts feeders for sorting parts and systems and methods therefor.

### BACKGROUND

In a base implementation, step feeders for sorting and/or selecting parts consist of few basic components. A hopper which stores the parts prior to sorting. A lift to raise the parts to a linear conveyance system. A fixed mechanical track specific to the part, is used to singulate the parts. Any parts which do not align or are stacked are then recycled back to the hopper, typically through a fixed reject escarpment. To change the feeder to select for a new part, the existing mechanical track must be removed and the replaced with a new mechanical track specific to the part being sorted.

In a base implementation, a more advanced vision enabled feeder has a hopper to store the parts, a lift to raise the parts to a conveyance system, and a camera system having a wide field of vision which, when a known part is recognized, utilizes a robot enabled pick and place mechanism, to pick up the selected part. The conveyor runs continuously to passively reject both good and bad (i.e. rejected) parts back into the hopper. To select for a different part, the ‘end of arm’ tooling would be replaced with one specific to the new part to be selected.

A need exists for a flexible, high feed rate, rapid change over, full inspection parts feeder of the type described herein.

### SUMMARY OF PARTICULAR EMBODIMENTS

It will be appreciated by those skilled in the art that other variations of the embodiments described below may also be practiced without departing from the scope of the invention. Further note, these embodiments, and other embodiments of the present invention will become more fully apparent from a review of the description and claims which follow.

In one embodiment, there is described a parts feeder assembly which includes a hopper for receiving parts or other objects, a fixed depth lift operatively connected to an end of the hopper for driving received parts toward a conveyer, wherein the lift is controlled by a motor which can determine by use of an encoder the top end position of parts on the conveyer, the speed with which the parts are raised by the lift and the rate of acceleration/deceleration. At the top end of the lift, parts to be sorted are placed on the conveyor. The conveyor is also controlled by a motor which can determine by use of an encoder both the position of parts on the conveyor as well as conveyer speed. In operation, parts drop from the lift into a staging or accumulation area on the conveyor. Pre-staging singulation of parts is accomplished using an adjustable flex crowder comprising substantially a crowder landing member, a flex crowder member comprised of a flexible material, and a singulator crowder member. The flex crowder functions to control the passage of parts of varying sizes and/or shapes along the conveyor. The crowder landing member is a walled member positioned substantially perpendicular to the upper surface of the conveyor, which acts as a back stop for parts raised from the lift onto the conveyor to ensure that these parts remain on the conveyor. The crowder landing member is positioned in the vicinity of the lift egress. The singulator crowder member is a walled member also positioned substantially perpendicular to the conveyor. The singulator crowder member is positioned downstream from the lift egress and functions to guide singulated parts along the conveyor for selection. Both the crowder landing member and the singulator crowder member are adapted for movement in a horizontal plane toward and away from the conveyor). A flex crowder member is disposed between the crowder landing member and the singulator crowder member for the purpose of linking these members together. The flex crowder member is composed of a flexible material and the placement and material composition of the flex crowder member allow the flex crowder member to slide and flex, and change in shape in relation to the length of the conveyor adjacent to the flex crowder member in response to the movement of the adjacent members of the flex crowder forward and away from the conveyor. In particular, the size, shape and flexibility of the flex crowder member 90 promotes the gradual acceleration of parts as they move along the conveyor, and a gradual deceleration. An angled destacker functions to deflect stacked parts while reducing the occurrence of parts jamming by variance of its pinch point angle. The destacker is an angled divergence plate moveably attached to the leading end of the singulator crowder member for the purposes of enabling movement of the destacker up and down in a vertical plane substantially perpendicular to the upper surface of the conveyor depending on the characteristics of the parts to be sorted. Parts are singulated as they pass along the conveyor from the area in the vicinity of the flex crowder member to the area of the conveyor in the vicinity of the singulator crowder member. Once parts are positioned on the moving conveyor in the vicinity of the singulator crowder member, the singulator crowder member is moveable to position parts in the field of view of a camera, which operates as part of a linked, computer implemented system to identify parts to be selected or rejected. When a non-compliant part is identified, the system transmits instructions to a processor associated with the at least one blower to activate and the at least one part removal apparatus (such as a blower or a combination of a plurality of blowers) in order to remove the part from the conveyor. A bumper or abutment is affixed on or near the leading edge of the singulator crowder member, wherein the lower edge of the bumper is in contact with, or is close to contact with, the upper surface of the conveyor. When the parts feeder is in operation, parts which come into contact with the bumper are forced away from the singulator crowder member, which in turn enables an at least one blower disposed downstream from the bumper to pick up additional venture effect air volume.

### BRIEF DESCRIPTION OF THE DRAWINGS

In the drawings, preferred embodiments of the invention are illustrated by way of example. It is to be expressly understood that the drawings are only for the purpose of illustration and as an aid to understanding and are not intended as a definition of the limits of the invention. The embodiments herein will be understood from the following description with reference to the drawings, in which:

FIG. 1 is a front elevation view of a parts feeder in accordance with one embodiment of the present disclosure with the front housing component removed.

FIG. 2 is a front perspective view of an isolated flex crowder component shown in FIG. 1.

FIG. 3 is a front elevation view of the flex crowder of FIG. 2.

FIG. 4 is a front perspective view of the parts feeder of FIG. 1.

FIG. 5 is a top plan view of the parts feeder of FIG. 4.

FIG. 6 is a rear elevation view of the parts feeder of FIG. 4

FIG. 7 is a left side elevation view of the parts feeder of FIG. 4.

FIG. 8 is a front perspective view of the parts feeder of FIG. 1.

FIG. 9 is a top perspective view of the parts feeder of FIG. 1.

FIG. 10 is an alternative top perspective view of the parts feeder of FIG. 1.

### DETAILED DESCRIPTION OF EXAMPLE EMBODIMENTS

In this respect, before explaining at least one embodiment of the invention in detail, it is to be understood that the invention is not limited in its application to the details of construction and the arrangements of the components outlined in the following description or illustrated in the drawings. The invention is capable of other embodiments and of being practiced and carried out in various ways. Also, it is to be understood that the phraseology and terminology employed herein are for the purpose of description and should not be regarded as limiting. In particular, all terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, the stated features and/or configurations or embodiments thereof the suggested intent may be applied as seen fit to certain operating conditions or environments by one experienced in the field of art.

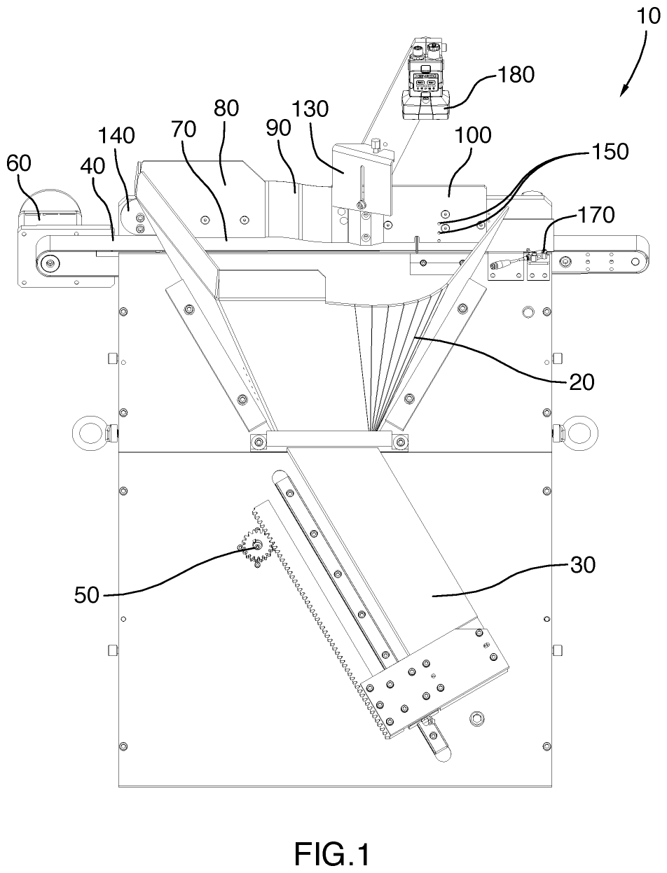

In an example embodiment, as shown in FIG. 1, a parts feeder assembly is indicated generally by reference numeral 10. In a base implementation, the parts feeder includes a hopper 20 for receiving parts or other objects. A fixed depth lift 30 operatively connected to an end of the hopper 20 functions to drive received parts toward a conveyer 40, wherein the lift 30 is housed within a feeder housing, having front, back, side and top and bottom housing components. In the embodiment shown, the lift 30 is controlled by a motor 50 (or equivalent) which can determine by use of an encoder (or equivalent) (not shown) the top end position of parts on the conveyer 40, the speed with which the parts are raised by the lift 30 and the rate of acceleration/deceleration. In this regard, if the speed and acceleration are set too high, these parts (e.g. especially smaller parts) may be ejected out of the feeder. The encoder can be attached to the shaft of the motor 50. In the embodiment shown in FIG. 1, the lift 30 is a fixed width design for supporting a wide range of parts of various shapes and sizes, and rapid change overs. Conventional apparatuses use variable width lifts to assist with part control, where in narrow width lifts are generally used for smaller and/or cylindrical shaped parts and wider lifts are used for larger parts.

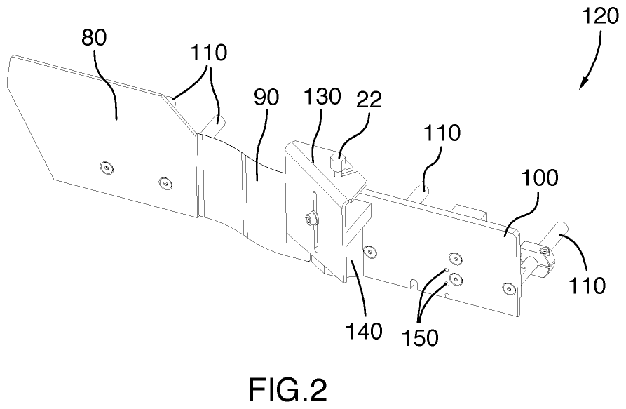

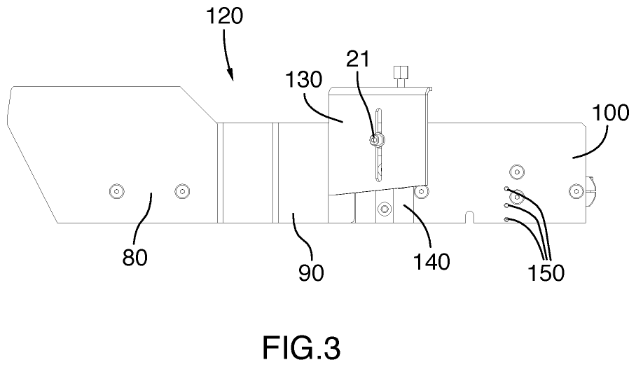

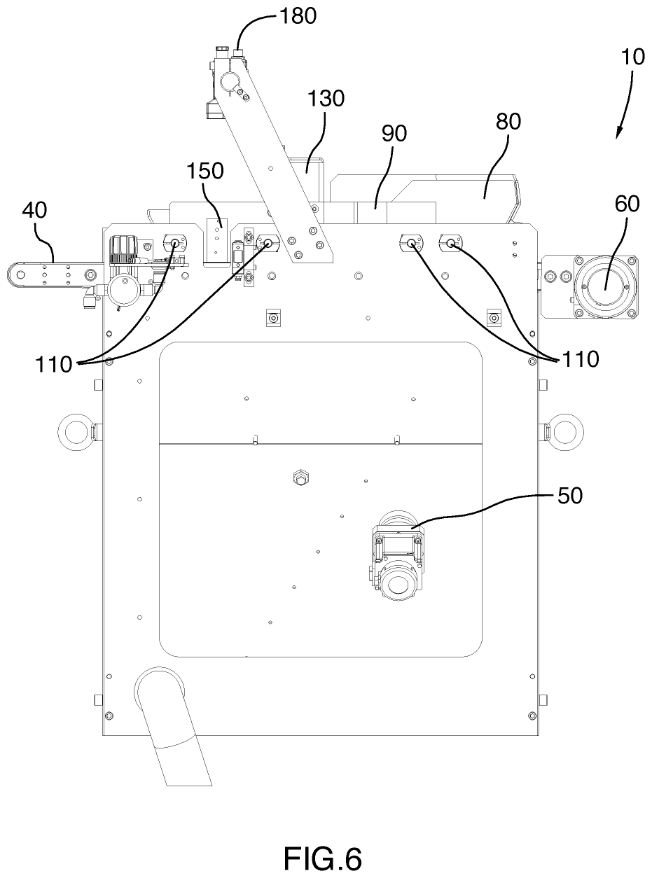

At the top end of the lift 30, parts to be sorted (not shown) are placed on the conveyor 40. The conveyor 40 is also controlled by a motor 60 (or equivalent) which can determine by use of an encoder (not shown) both the position of parts on the conveyor 40 as well as conveyer speed. In the embodiment contemplated, the encoder is an electro-mechanical device which converts the angular position of the motor 60 into digital pulses. For example, if the encoder has 360 increments, each pulse would indicate 1 degree of rotation of the shaft (not shown) of the motor 50. By operation of the encoder, the parts feeder assembly 10 is able to synchronize the cycle of the lift 30 with the speed of the conveyor 40 such that parts on the conveyor 40 will clear the deposit of a new batch of parts being placed on the conveyor. If parts are placed on the conveyor 40 without clearing the preceding batch, excessive parts are rejected, and cycle time goes down. In contrast, when the preceding parts are cleared off, cycle time goes up as system capacity increases. Still referring to FIG. 1, in operation, parts drop from the lift 30 into a staging or accumulation area 70 on the conveyor 40. Pre-staging singulation of parts is accomplished using an adjustable flex crowder 120 comprising substantially a crowder landing member 80, a flex crowder member 90 comprised of a flexible material, and a singulator crowder member 100. The flex crowder 120 component is isolated and shown in detail in FIGS. 2 and 3. The flex crowder 120 functions to control the passage of parts of varying sizes and/or shapes along the conveyor 40. The crowder landing member 80 is a walled member positioned substantially perpendicular to the upper surface of the conveyor 40, which acts as a back stop for parts raised from the lift 30 onto the conveyor 40 to ensure that these parts remain on the conveyor 40. The crowder landing member 80 is positioned in the vicinity of the lift 30 egress. The crowder landing member 80 must be of a height sufficient to prevent parts from being unintentionally launched over the crowder landing member 80 by the lift 30 and out of the feeder 10. The crowder landing member 80 is operatively connected to an at least one adjusting rod (or movement member) 110 affixed to the feeder assembly on the side of the crowder landing member 80. In the embodiment shown in FIG. 6, the at least one adjusting rod 110 associated with the crowder landing member 80 is affixed to a back wall of the feeder 10. The at least one adjusting rod 110 associated with the crowder landing member 80 can be controlled to extend and retract in a horizontal axis parallel to the horizontal axis of the conveyor 40 in order to move the crowder landing member 80 forward or backward from the edge of the conveyor 40.

The singulator crowder member 100 is a walled member also positioned substantially perpendicular to the conveyor 40. The singulator crowder member 100 is positioned downstream from the lift 30 egress and functions to guide singulated parts along the conveyor 40 for selection. The singulator crowder member 100 is also operatively connected to an at least one adjusting rod (or movement member) 110 affixed to the feeder assembly on the side of the singulator crowder member 100. In the embodiment shown in FIG. 6, the at least one adjusting rod 110 associated with the singulator crowder member 100 is affixed to a back wall of the feeder 10. The at least one adjusting rod 110 associated with the singulator crowder member 100 can be controlled to extend and retract in a horizontal axis parallel to the horizontal axis of the conveyor 40 in order to move the singulator crowder member 100 forward or backward from the edge of the conveyor. The singulator crowder member 100 can be a shorter height than the height of the crowder landing member 80 since there is no force acting on the parts in the vicinity of the singulator crowder member 100 which could eject said parts out of the feeder 10. In one embodiment, the height of member 80 is approximately 25% higher than the height of member 100.

It should also be mentioned that the singulator crowder member 100 can also be moved close to the edge of the conveyor 40 on the side of the conveyor 40 opposite the singulator crowder member 100 in order to force non-aligned parts moving on the conveyor 40 in the vicinity of the singulator crowder member 100 back into the hopper 20.

Once parts are positioned on the moving conveyor 40 in the vicinity of the singulator crowder member 100 (e.g. parts on the conveyor adjacent to member 100), the singulator crowder member 100 is moveable to position parts in the field of view of a camera 180, which camera 180 is positioned above the conveyor 40 in the vicinity of the singulator crowder member 100.

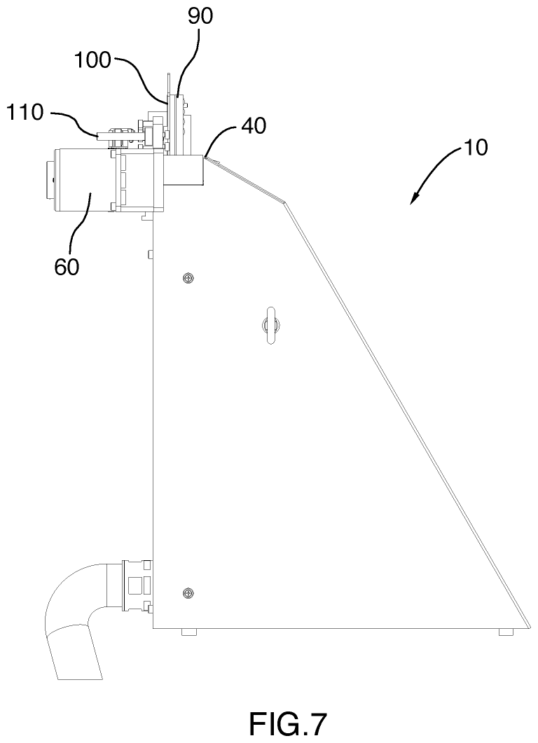

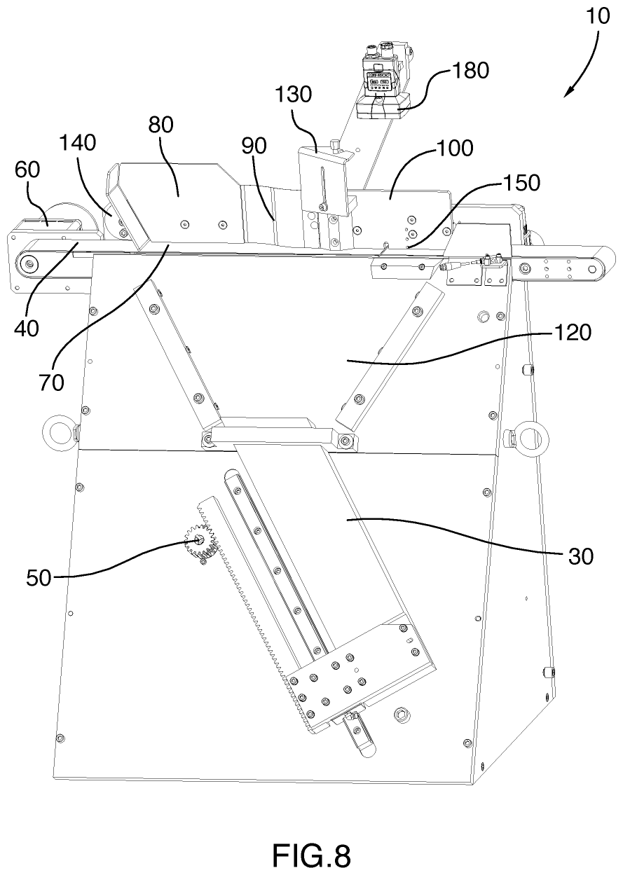

Referring to FIGS. 1 and 8, since the crowder landing member 80 and the singulator crowder member 100 can be set at different positions relative to the edge of the conveyor 40 depending on the characteristics of the parts to be sorted, a flex crowder member 90 is disposed between members 80 and 100 for the purpose of linking members 80 and 100 together. The flex crowder member 90 is composed of a flexible material (such as spring steel or other thin, flexible and durable material) and, in the embodiment shown in FIG. 1, is attached to one end of the crowder landing member 80 at a first end of member 90 and to one end of the singulator crowder member 100 at a second end of member 90, wherein the first and second ends of member 90 are opposite one another. The placement and material composition of the flex crowder member 90 allow the flex crowder member 90 to slide and flex, and change in shape in relation to the length of the conveyor 40 adjacent to the flex crowder member 90 in response to the movement of members 80 and 90 forward and away from the conveyor 40. In particular, the size, shape and flexibility of the flex crowder member 90 promotes the gradual acceleration of parts as they move along the conveyor 40, and a gradual deceleration (as opposed to a rapid acceleration followed by an abrupt deceleration), when the flex crowder member 90 takes on an s-curve, or slight s-curve configuration (for example, where member 80 and member 100 are not in parallel alignment, and where member 100 is closer to the leading edge of the conveyor 40 than member 80). The thin construction and elasticity (or flex) of the flex crowder member 90 further facilitates the smooth transition of parts along the conveyor 40 from member 80 to member 100, as the flex crowder member 90 can cradle (or absorb the force of) parts that come into contact with it, as opposed to a straight-wall, inflexible configuration. In the flex crowder 120 embodiment shown in FIG. 2, the flex crowder 120 is adjusted and held in place by at least two adjusting rods 110. In the embodiment shown in FIG. 2, the rods 110 are solid cylindrical shafts affixed to the back sides of members 80 and 100. These rods 110 can be passed through rod clamps such that when the rod clamps are closed or compressing on the rod 110 shafts, the rods 110 are locked in place in a fixed position. Adjustment of the position of the members 80 and 100 can be accomplished manually by releasing the compression on the rod clamps, moving the rods 110 in or out to set the members 80 and 100 in position from the edge of the conveyor 40, and then tightening the clamps again which compresses the clamps onto the rods 110, thereby holding the rods in place. Alternative mechanical or automated systems can be employed to effect movement of the members 80 and 100 without deviating from the scope of the present invention. The rods 110 can also be seen in FIGS. 6 and 7, which present rear and side elevation views of the parts feeder 10, respectively.

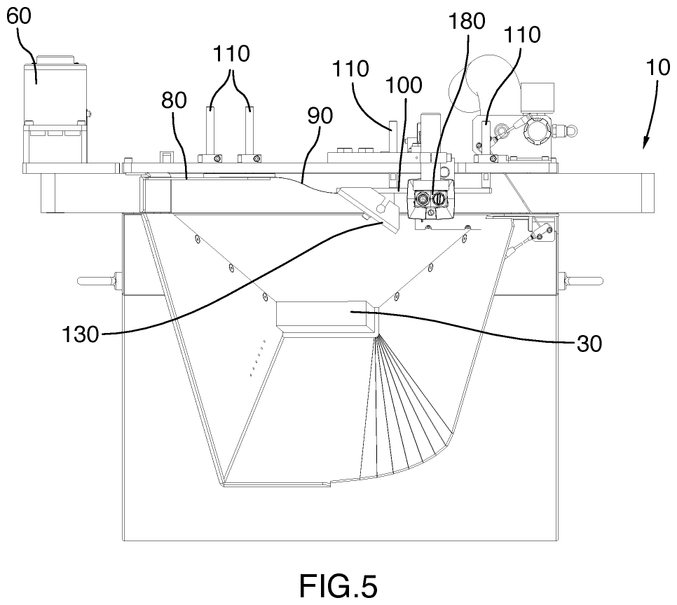

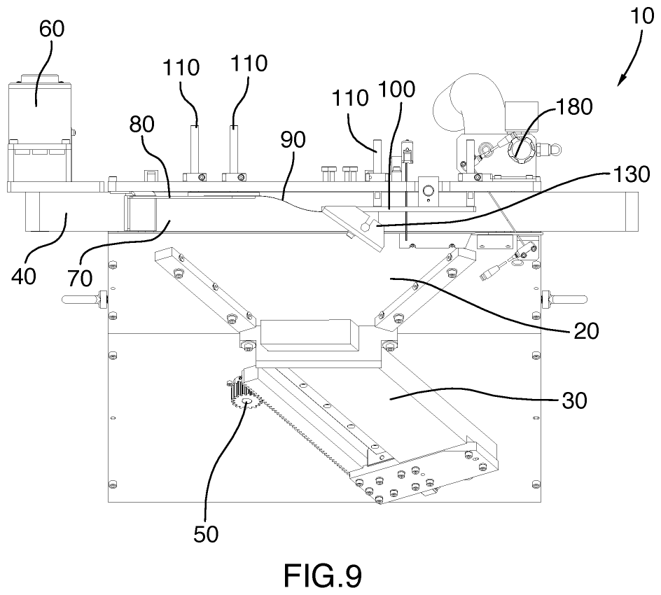

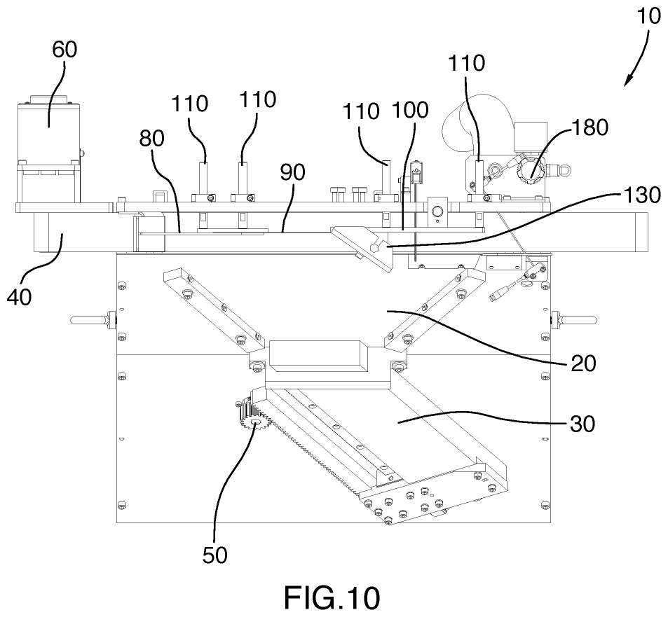

As previously indicated, the flex crowder 120 functions to retain and guide parts as they move along the conveyor 40. On the conveyor 40 in the vicinity of the crowder landing member 80, the parts dropped onto the conveyor 40 from the lift 30 are positioned in the staging area 70 on the conveyor 40. An alternative view of the staging area 70 is depicted in FIG. 5. Use of a staging area 70 allows some parts to settle into position as well as to accumulate as they move along the conveyor 40. Smaller parts falling onto the staging area 70 of the conveyor 40 can be controlled by setting the crowder landing member 80 close to the conveyor 40 and setting the singulator crowder member 100 away from the conveyor 40 by manipulating the adjusting rods 110 associated with the crowder landing member 80. Larger parts are controlled in the staging area 70 by setting the crowder landing member 80 further away from the conveyor 40 and staggered back of the singulator crowder member 100 using the by manipulation of the adjusting rods 110 associated with the singulator crowder member 100 (see FIG. 9 for an example of this flex crowder configuration). When cylindrical type parts are to be sorted, both the crowder landing member 80 and singulator crowder member 100 can be set at a co-linear setting (see FIG. 10) wherein the members 80 and 100 are positioned away from the conveyor 40 based on the size/diameter of the parts in question.

The flex crowder 120 feature reduces or eliminates the need to employ a feeder using lifts of varying depths and widths including feeders which utilize multiple lifts of different sizes And the flex crowder member 90 which is disposed between and connected to each of the members 80, 100 makes up any difference in alignment between members 80 and 100 and thereby allows for a smooth transition of parts from the crowder landing member 80 to the singulator crowder member 100. When the feeder 10 is in operation, as parts move on the conveyor 40 from a position in the vicinity of the crowder landing member 80 and past the flex crowder member 90 to the singulator crowder member 100, any stacked parts and/or crowded parts (i.e. parts positioned side-by-side) are diverted back to the hopper 20 to be recycled through the process again. FIG. 5 illustrates a top plan view of the parts feeder 10 showing the configuration of key components of the flex crowder, being members 80, 90, 100, wherein members 80 and 100 are not in co-alignment.

The base concept of a step feeder is to align or singulate the parts such that the parts can then be fed either into a fixed escarpment or positioned in the field of view of a vision system associated with the step feeder. The conventional lift is of a fixed with and parts not aligned initially fall off the lift back into the hopper. With this type of system, the staging area is fixed so that as the parts move along the conveyor, they are further aligned. For large parts and/or cylindrical parts a wider lift is needed. The system of the present invention uses a different approach. All parts (i.e. small, large and/or cylindrical) are raised by a lift of defined width. The flex crowder staging or accumulation area 70, can be adjusted to a position either close to the edge of the conveyor 40 or set back from the edge of the conveyor 40. If a part being staged needs to be tipped back into the hopper 20, then the crowder landing member 80 can be moved forward close to the edge of the conveyor 40, in a similar manner to using a lift of narrow depth—but rather than have the parts tip back into the hopper 20 because the lift is too narrow to support them, in the case of the present invention, the parts tip back into the hopper 20 since the staging or accumulation area 70 has been narrowed by movement of the crowder landing member 80. In contrast, when larger parts are to be selected, since the lift is already of a fixed, wide depth to accommodate larger sized parts, the staging area 70 can be set wider by moving the crowder landing member 80 further away from the edge of the conveyor 40.

An angled destacker, shown generally by reference numeral 130 functions to deflect stacked parts while reducing the occurrence of parts jamming by variance of its pinch point angle. In the embodiment shown in FIG. 1, the destacker 130 is an angled divergence plate moveably attached to the leading end of the singulator crowder member 100 for the purposes of enabling movement of the destacker 130 up and down in a vertical plane substantially perpendicular to the upper surface of the conveyor 40. Throughout this disclosure, the term “substantially” and other adjectives, descriptive terms and/or comparators, are intended to be defined by their common dictionary meanings. The destacker 130 functions to divert parts that may be positioned on their edge or to divert parts that may be stacked one on top of another. The height of the destacker 130 (i.e. the space between the lower surface (or lower edge) of the destacker 130 and the upper surface of the conveyor 40) can be raised or lowered in order to set the destacker 30 lower edge height in relation to the height of the part to be fed. Once the desired height of the destacker 30 lower edge is reached, the position can be locked in place (for example, using a locking bolt associated with the destacker 130). In operation, the height of the lower edge of the destacker 130 from the top of the conveyor 40 is typically set at 1.1 to 1.25 times the height of the part to be fed. If the height of the lower edge of the destacker 30 is set too low, then many (or all) parts will be diverted back into the hopper. In contrast, if the lower edge of the destacker 130 is set too high, then many (or all) parts (e.g. one edge or stacked on top of each other) could pass under the destacker 130 into the field of view of the camera 180. In the embodiment shown in FIG. 1, the lower edge of the destacker 130 is angled as opposed to straight-edged. This feature allows parts that are stacked and which may otherwise jam on a parallel edge to the conveyor 40 to be directed back into the hopper 20 as the side forces moving the part along the conveyor 40 reduce or relieve the pinch point. If the lower edge of the destacker 130 is not angled, then there is no effective mechanism in place to relieve the pinch point (wherein parts are caught under the destacker 130 as the conveyor 40 continues to move). The FIG. 1 embodiment is intended to show a destacker lower edge angle of approximately 5 degrees, however, different angles could be utilized without affecting the function of the destacker 130. For example, the angle could be within the range of 4 to 10 degrees and outliers of this range, however, if the angle is too big or too small, functionality could be compromised.

As mentioned, parts are singulated as they pass along the conveyor 40 from the area in the vicinity of the flex crowder member 90 to the area of the conveyor in the vicinity of the singulator crowder member 100. In the flex crowder 120 embodiment shown in FIGS. 2 and 3, a bumper (or bump bar) 140 is provided (or other part removal apparatus). In the embodiments shown in FIGS. 2 and 3, the bumper 140 is removably affixed on or near the leading edge of the singulator crowder member 100, (but behind the destacker) wherein the lower edge of the bumper 140 is in contact with, or is close to contact with, the upper surface of the conveyor 40. In the embodiments shown in FIGS. 2 and 3, the bumper 140 is positioned behind the destacker 130 and has a substantially flat-topped prism shaped, comprising a forward-most wall and tapered sidewalls. When the parts feeder 10 is in operation, larger, flat parts (in particular) which come into contact with the bumper 140 are forced away from the singulator crowder member 100, which in turn enables an at least one blower 150 disposed downstream from the bumper 140 to pick up additional venture effect air volume (as a result of the spacing between the at least one blower 150 air output and the rear-ward most member of the part on the conveyor 40) enabling these larger flat surfaced parts to be removed from the conveyor 40. In the embodiments shown in FIGS. 2 and 3, a plurality of blowers 150 are disposed on a forward facing wall of the singulator crowder member 100. Each of the plurality of blowers 150 is connected to an air source, such as a compressor (not shown) and has an aperture for transmitting air from the air source to an area on the conveyor 40 in the vicinity of the singulator crowder member 100 and downstream from the bumper 140. In the embodiments shown in FIGS. 2 and 3, the blowers 150 are positioned below the medial portion of the singulator crowder member 100 in close proximity to the upper surface of the conveyor 40. As the parts feeder 10 of the present invention is designed to accept a wide variety of parts, large flat surface parts, such as nuts are difficult to displace from the conveyor 40 back into the hopper 20. Further, if a large part is positioned at or against the forward facing wall of the singulator crowder member 100, substantial force would be required to dislodge such part from contact with member (owing in part to surface-to-surface adhesion). By moving (or “kicking”) the part off the singulator crowder member by use of the bumper 140, allows the at least one blower 150 to pick up extra air volume as well as eliminate any possible partial low-pressure effect (surface to surface adhesion) present between the nut surface and the crowder surface in order to remove such part from the conveyor 40 using less force than would otherwise be required. To maximize part blow off pressure and volume, the at least one blower 150 can be attached to the singulator crowder member 100 such that the at least one blower 150 moves as the singulator crowder member 100 moves. In addition, the at least one blower 150 can be will be adapted to generate either a single pulse of air or multiple pulses, depending on the size and shape of the part to be removed. Multiple pulses of air can be particularly effective at removing larger heavier parts, long parts or parts such as coiled springs that are not solid and would rely on multiple pulses to catch the solid wire.

As different parts have different shapes, sizes, heights and centers of gravity, the push point or blow off point of a given part will vary from the upper surface of the conveyor 40 to typically the mid-point from the bottom of the conveyor to the top of the part. For example, parts such as washers which lie very close to the conveyor 40 surface require a low blow off point close to the conveyor 40 surface. In contrast, mid-size parts such as a ¾ inch nut may require a blow off point above the base of the conveyor 40. To accommodate a wide variety of parts of various shapes and sizes, heights and centers of gravity, a multiple blow off manifold with multiple jet outlet locations (or blowers 150) is used. Setting the location of the blow off point(s) is as simple as removing set screws from the manifold for desired location(s) and placing in set screws for blocking individual blowers 150.

Since parts on a conveyor may be prone to rolling (including cylindrical-shaped parts), the parts feeder 10 of the present invention may be adapted to slightly tilt the parts feeder (or the conveyor 40 portion of the parts feeder) to create a slight incline (e.g. 1 degree, or 1 to 5 degrees) on the conveyor 40 as parts move from the staging area 70 through the singulation crowder member 100 zone of the conveyor 40. This allows for cylindrical parts to be stabilized while traveling through the camera 180 field of view on the conveyor 40, while also not impeding the part from being rejected.

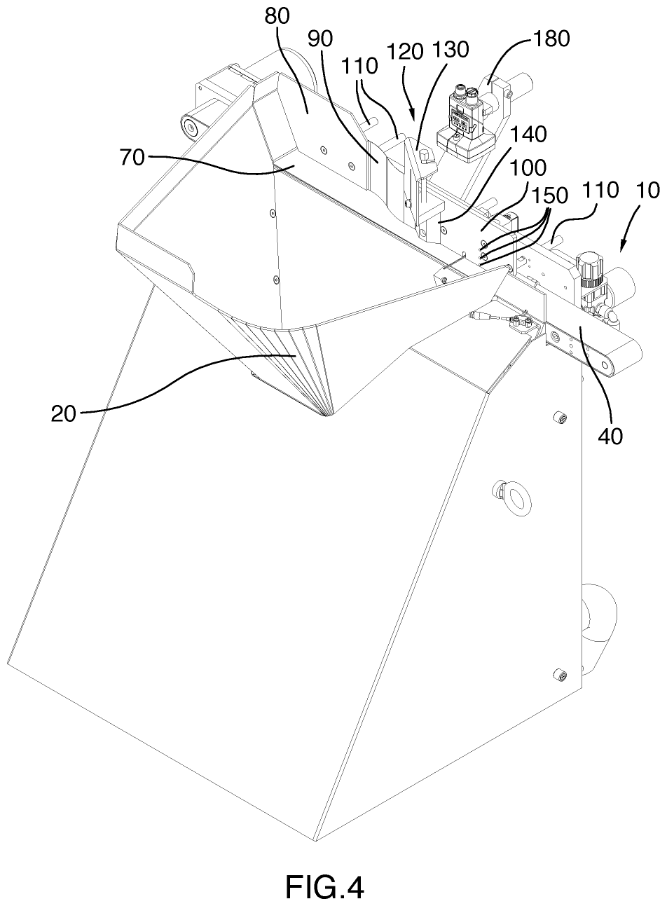

Now referring to FIG. 4, in an example implementation, when the parts feeder 10 is in operation, as the singulated part(s) move(s) on the conveyor 40 past the bumper 140 into the vicinity of the singulated crowder member 100, the leading edge of the part activates a sensor (such as a laser trigger sensor), which sensor functions to set the initial reference point for the start of the pulse count of the encoder associated with the conveyor 40. By counting the pulses from the leading edge of the part and trailing edge of the part, the position of the part is known as it travels along the conveyor 40.

The part continues to move along the conveyor 40, wherein the position of the part has now been located by the laser trigger sensor to identify the leading-edge trigger set point and the position of the part on the conveyor based on the encoder count readings. The encoder count readings may be transmitted from the encoder for processing as part of a computer implemented system, wherein key components of the system are in network communication with one another in order to produce a set out outputs. A processor may be employed to receive and analyze the encoder count readings and transmit instructions to the camera 180 to take an image of the part when the part reaches the focal area for the camera 180, on the conveyor 40. A computer associated with a memory having stored thereon a database of existing part images, can be employed to receive a transmission of the image in question and compare the image in question to the images in the database using a proprietary algorithm based on input from the network linked camera, laser trigger sensor, and conveyor encoder for the purpose of identifying a non-compliant part. When a non-compliant part is identified, the system transmits instructions to a processor associated with the at least one blower 150 to activate and the at least one blower 150 or a combination of a plurality of blowers in order to remove the part from the conveyor 40.

In the case where a part is identical dimensionally to another part but only distinguishable by color, then the algorithm is set up to compare multiple (2 or more) images to determine a non-compliant part. When a part is identical to another with all physical dimensions and distinguishable only by color or finish, multiple camera images are then considered in the algorithm.

The part continues to move along the conveyor, the position is still being reference based on the pulse counts provided by the conveyor encoder. The part would then reach the part reject location or blow off. If the algorithm has determined that the part is non-compliant, then the blow-off pulse is activated. Typically, and by default the program is set up for a single reject/blow off pulse and is activated in, or approximately in, the center location of the part. In some cases, multiple blow off pulses will be required. The location of the blow off may be determined not to be the part center and may be activated ahead or after the center of the part which can be located by the leading edge of the laser trigger point as well as the location based on the pulse count from the encoder associated with the conveyor motor.

The algorithm monitors parts as they pass under the camera 180. If after a set period of time where parts are no longer being sensed as present, the system interprets this as a jam. At this point the conveyor stops, the lift is deactivated and the conveyor cycles in reverse to remove parts from the conveyor and from the destacker. Once the cycle concludes, normal operation resumes.

Consider the following jam clearing examples. The first is based on a situation where the destacker 130 cannot clear multiple level parts. In this case the conveyor 40 would continue to run however no images would be recorded by the camera 180. If after a set period of time (e.g. fifteen seconds), the system would assume a jam and go into a jam recovery cycle, wherein the conveyor motor 60 would move in a reverse direction. The lift motor 50 moves the lift to a lower position and remains there for the cycle, and any parts jammed under the destacker 130 would travel back to the conveyor landing area adjacent to member 80 and be directed back into the hopper 20. While the conveyor 40 reverses the blow off pulses of the at least one blower 150, any parts that are on the discharge member of the conveyor are returned back into the hopper 20 to be recycled. If the jam has cleared, the parts traveling along the conveyor 40 will now trigger an escapement sensor 170 which would reset a jam cycle count to zero. If a jam is still present a jam cycle count would increase by one and the jam recovery cycle would repeat. This cycle will repeat for three times or until the jam cycle count reaches three. If after the third time a jam is still being detected, the system will shut down a wait for technically assistance. The system will not restart until the system is reset. The escapement sensor 170 functions to monitor parts as they are being discharged through the escapement (e.g. the end of the conveyor 40, or conveyor roll-off member). If the escapement sensor 170 remains activated typically for a period of fifteen seconds, if is considered that there is an issue at the discharge of the parts. This would not be considered a feeder problem but to moderate the feeder, the conveyor motor 60 and the lift motor 50 would stop until the issue is resolved and parts resume feeding.

At some point the current part being run requires a change over to a new part. When this happens, the hopper 20 may be empty, partially full or completely full. Feeders are typically emptied by either scooping or manually picking the parts out or by continuing to run the system and switching a form of gate mechanism. At times this gate mechanism is not easily or safely accessible. The feeder 10 of the present invention uses an empty hopper cycle, wherein a back gate 190 is removed and an empty bin cycle is initiated which has the lift 30 operate as normal but in this case the conveyor 40 is reversed. The parts are then discharged to an area which is typically not the production member. The feeder allows for a hopper empty cycle by opening the back gate 190 and reversing the conveyor 40 while the lift 30 continues to cycle.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any modification, combination or permutation of any of the components, elements, functions, operations, or steps described or illustrated anywhere herein that a person having ordinary skill in the art would comprehend. All such modifications, combinations and permutations are believed to be within the sphere and scope of the invention as defined by the claims appended hereto.

We claim:

1. A parts feeder for singulating parts, comprising:
a hopper for receiving parts;
a conveyor for transporting parts;
a lift operatively connected to an end of the hopper for driving received parts to the conveyor;
a crowder landing member positioned substantially perpendicular to the upper surface of the conveyor, the crowder landing member disposed in the vicinity of the path of exit of the lift, the crowder landing member adapted for movement within a horizontal plane forward and away from the conveyor;
a singulator crowder member positioned substantially perpendicular to the upper surface of the conveyor, the singulator crowder member disposed downstream from the crowder landing member, the singulator crowder member adapted for movement within a horizontal plane forward and away from the conveyor; and
a flex crowder member disposed between and connected to each of the crowder landing member and the singulator crowder member, the flex crowder member comprised of a flexible material for facilitating the movement of parts along the conveyor, including where the crowder landing member and singulator crowder member are not aligned in relation to the conveyor.

2. The parts feeder of claim 1 wherein the lift is of a fixed depth.

3. The parts feeder of claim 1 wherein the lift is housed in a feeder housing.

4. The parts feeder of claim 1 further comprising a destacker disposed between the crowder landing member and the singulator crowder member on the same side of the conveyor as the crowder landing member and the singulator crowder member, the destacker moveable in a vertical plane perpendicular to the upper surface of the conveyor, the destacker functioning to deflect stacked parts or prevent the movement of parts of undesired shape or size past the destacker.

5. The parts feeder of claim 4 wherein the destacker has an angled lower edge.

6. The parts feeder of claim 5 wherein the angle is between 4 and 10 degrees.

7. The parts feeder of claim 4 wherein the destacker is attached to the leading edge of the singulator crowder member.

8. The parts feeder of claim 1 wherein the flex crowder member changes in shape in relation to the length of the conveyor adjacent to the flex crowder member in response to the movement of the crowder landing member and the singulator crowder member forward and/or away from the conveyor.

9. A parts feeder for sorting parts, comprising:
a hopper for receiving parts;
a conveyor for transporting parts;
a lift operatively connected to an end of the hopper for driving received parts to the conveyor;
a crowder landing member positioned substantially perpendicular to the upper surface of the conveyor, the crowder landing member disposed in the vicinity of the path of exit of the lift, the crowder landing member adapted for movement within a horizontal plane forward and away from the conveyor;
a singulator crowder member positioned substantially perpendicular to the upper surface of the conveyor, the singulator crowder member disposed downstream from the crowder landing member, the singulator crowder member adapted for movement within a horizontal plane forward and away from the conveyor;
a flex crowder member disposed between and connected to each of the crowder landing member and the singulator crowder member, the flex crowder member comprised of a flexible material for facilitating the movement of parts along the conveyor, including where the crowder landing member and singulator crowder member are not aligned in relation to the conveyor;
a camera positioned in the vicinity of the singulator crowder member, the camera for recording images of singulated parts on the conveyor to produce an image data set;
a processor linked to the camera for analyzing the image data set and identifying parts to be removed from the conveyor; and
an at least one part removal apparatus in operative communication with the processor, the at least one part removal apparatus disposed downstream from the camera, the at least one part removal apparatus operable to effect the removal a part from the conveyor.

10. The parts feeder of claim 9 further comprising a destacker disposed between the crowder landing member and the singulator crowder member on the same side of the conveyor as the crowder landing member and the singulator crowder member, the destacker moveable in a vertical plane perpendicular to the upper surface of the conveyor, the destacker functioning to deflect stacked parts or prevent the movement of parts of undesired shape or size past the destacker.

11. The parts feeder of claim 9 further comprising a bumper disposed downstream from the destacker on the same side of the conveyor as the at least one blower, the bumper for forcing rejected parts away from the singulator crowder member.

12. The parts feeder of claim 11 wherein the bumper is affixed at or near the leading edge of the singulator crowder member.

13. The parts feeder of claim 9 wherein the part removal apparatus is an at least one blower connected to an air source.
